(19) United States
(12) Patent Application Publication
(10) Pub. No.: US 2026/0261686 A1
(43) Pub. Date: Sep. 3, 2026

(54) Low Bit Rate Video Compression With Generative Video Models

(71) Applicants: Disney Enterprises, Inc., Burbank, CA (US); ETH Zürich (EIDGENÖSSISCHE TECHNISCHE HOCHSCHULE ZÜRICH), Zürich (CH)

(72) Inventors: Andre Emmenegger, Zürich (CH); Lucas Relic, Zürich (CH); Roberto Gerson de Albuquerque Azevedo, Zürich (CH); Yang Zhang, Dübendorf (CH); Christopher Richard Schroers, Uster (CH)

(21) Appl. No.: 19/446,235

(22) Filed: Jan. 12, 2026

Related U.S. Application Data
(60) Provisional application No. 63/766,197, filed on Mar. 3, 2025.

(51) Int. Cl. H04N 19/159; H04N 19/119; H04N 19/172

(52) U.S. Cl. CPC H04N 19/159; H04N 19/119; H04N 19/172

(57) ABSTRACT

A system includes a video decoder, and a video encoder including a processor configured to execute video compression software code to partition video frames into video keyframes and video inter-frames, encode the video keyframes to generate encoded video keyframes, process, using an optical flow model, the video inter-frames to produce forward flows from the video inter-frames to a first video keyframe and backward flows from the video inter-frames to a second video keyframe, generate, using the forward and backward flows, bidirectional flow maps corresponding respectively to the video inter-frames, encode the bidirectional flow maps to provide video decoding metadata, and generate a bitstream including the encoded video keyframes and the video decoding metadata. The video decoder receives the bitstream and produces reconstructed video frames corresponding to the video frames including the video keyframes and the video inter-frames using a generative video model.

### RELATED APPLICATIONS

The present application claims the benefit of and priority to a pending U.S. Provisional Patent Application Ser. No. 63/766,197 filed on Mar. 3, 2025, and titled “Video Compression with Diffusion Models,” which is hereby incorporated fully by reference into the present application.

### BACKGROUND

The substantial and growing fraction of internet bandwidth taken up by video data traffic necessitates ongoing advancements to video compression algorithms in order to reduce stress on global internet infrastructure. The objective of such compression algorithms is to optimize bandwidth usage and improve storage efficiency, while ensuring minimal distortion. However, when compressing video to low bit rates, such as bit rates of approximately 0.03 bits per pixel for example, present state-of-the-art methods often produce blurry reconstructions which can contain undesirable artifacts such as blocking, ringing, or banding. While conventional state-of-the-art reconstructions can achieve low quantitative error metrics, those reconstructions tend to be significantly lacking in subjective visual quality, thereby diminishing the viewing experience of the end user. This result is due to what is known as the rate-distortion-perception triple tradeoff, which holds that at low bit rates it is possible to achieve either low distortion or high perceptual quality, but not both. Consequently, there is a need in the art for a low bit rate video compression solution capable of providing reconstructed video having both low distortion and high perceptual quality.

### BRIEF DESCRIPTION OF THE DRAWINGS

FIG. 1 shows a diagram of an exemplary system for performing low bit rate video compression with a generative video model, according to one implementation;

FIG. 2 shows a diagram of an exemplary encoder pipeline implemented by a video encoder included in the system shown in FIG. 1, according to one implementation;

FIG. 3 shows a flowchart outlining an exemplary method for use by the video encoder included in the system shown in FIG. 1, according to one implementation;

FIG. 4 shows a diagram of an exemplary decoder pipeline implemented by a video decoder included in the system shown in FIG. 1, according to one implementation; and

FIG. 5 shows a flowchart outlining an exemplary method for use by the video decoder included in the system shown in FIG. 1, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, the substantial and growing fraction of internet bandwidth taken up by video data traffic necessitates ongoing advancements to video compression algorithms in order to reduce stress on global internet infrastructure. As further noted above, the objective of such compression algorithms is to optimize bandwidth usage and improve storage efficiency, while ensuring minimal distortion. However, when compressing video to low bit rates, such as bit rates of approximately 0.03 bits per pixel for example, present state-of-the-art methods often produce blurry reconstructions which can contain undesirable artifacts such as blocking, ringing, or banding. While conventional state-of-the-art reconstructions can achieve low quantitative error metrics, they tend to be significantly lacking in subjective visual quality, thereby diminishing the viewing experience of the end user.

The present application discloses systems and methods for performing low bit rate video compression with generative video models that address and overcome a technical problem unique to computing and the internet by introducing a diffusion-based video codec. By way of overview, the approach to video compression disclosed in the present application operates by performing long-context interpolation guided by sparse inter-frame predictions, thus requiring minimal motion information. A sparse, bidirectional optical flow is generated which serves as motion conditioning in the generative video decoding process. The novel and inventive codec disclosed herein uses a generative video model to reconstruct the source video at the decoder side by operating on an entire group of pictures (GOP) at once, ensuring temporal consistency and allowing the codec to infer motion dynamics from the entire sequence, rather than a small frame buffer. As a result, this codec can compress videos to low bit rates, such as bit rates less than 0.025 bits per pixel, and even to extremely low bit rates, i.e., bit rates as low as 0.01 bits per pixel, while maintaining realistic textures and motion. Moreover, in some implementations, the systems and methods disclosed by the present application may be substantially or fully automated.

As used in the present application, the terms “automation,” “automated” and “automating” refer to systems and processes that do not require the participation of a human system operator. Thus, the methods described in the present application may be performed under the control of hardware processing components of the disclosed automated systems.

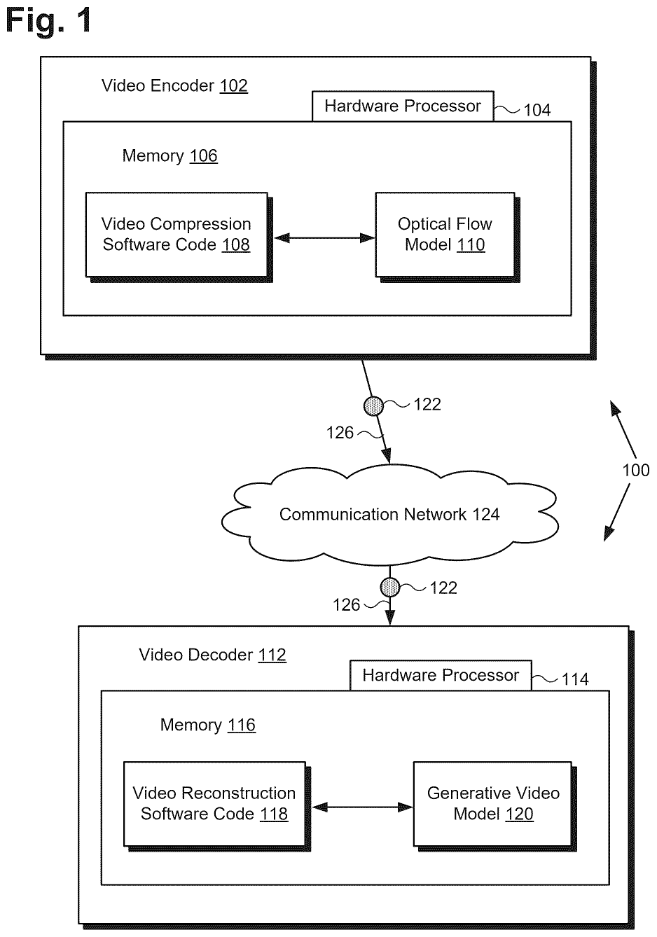

FIG. 1 shows exemplary system 100 for performing low bit rate video compression with a generative video model, according to one implementation. As shown in FIG. 1, system 100 includes video encoder 102 and video decoder 112. Also shown in FIG. 1 is bitstream 122 generated and output by video encoder 102, and received by video decoder 112 via communication network 124 and network communication links 126. It is noted that in some implementations, communication network 124 may be a packet-switched network such as the internet, for example. Alternatively, communication network 124 may take the form of a wide area network (WAN), a local area network (LAN), or may be another type of private or limited distribution network.

As further shown in FIG. 1, video encoder includes hardware processor 104 and memory 106 implemented as a computer-readable non-transitory storage medium having stored thereon video compression software code 108 and optical flow model 110. Moreover, FIG. 1 shows video decoder as including hardware processor 114 and memory 116 implemented as a computer-readable non-transitory storage medium having stored thereon video reconstruction software code 118 and generative video model 120, which may be a diffusion model, for example, such as a conditional latent diffusion model.

It is noted that memory 106 of video encoder 102 and memory 116 of video decoder 112 may take the form of any computer-readable non-transitory storage medium. The expression “computer-readable non-transitory storage medium,” as used in the present application, refers to any medium, excluding a carrier wave or other transitory signal that provides instructions to hardware processor 104 of video encoder 102 or to hardware processor 114 of video decoder 112. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Hardware processor 104 of video encoder 102 and hardware processor 114 of video decoder 112 may each include a plurality of hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as video compression software code 108 from memory 106 of video encoder 102, or video reconstruction software code 118 from memory 116 of video decoder 112, while a GPU may be implemented to reduce the processing overhead of the CPU by performing computationally intensive graphics or other processing tasks. A TPU is an application-specific integrated circuit (ASIC) configured specifically for artificial intelligence (AI) processes such as machine learning.

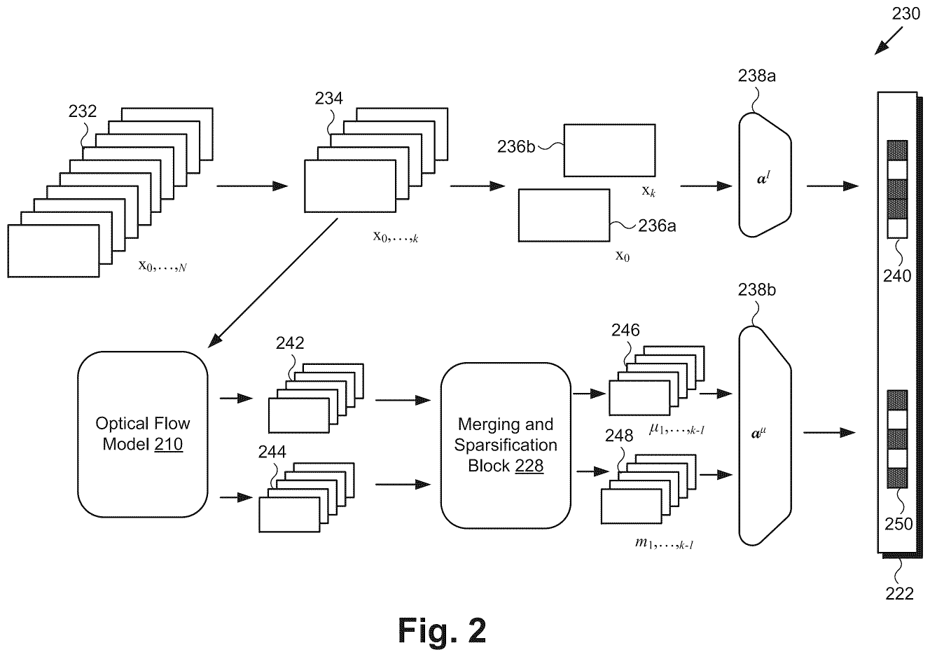

FIG. 2 shows a diagram of exemplary encoder pipeline 230 implemented by video encoder 102 in FIG. 1, according to one implementation. Encoder pipeline 230 is configured to receive video sequence 232 (x_{0, . . . , N}) including plurality of video frames 234 (x_{0, . . . , k}), which may be a Group of Pictures (GOP) or other subset of video frames included in video sequence 234 for example, and to generate bitstream 222 of compressed video data corresponding to plurality of video frames 234. It is noted that bitstream 222 corresponds in general to bitstream 122, in FIG. 1, and those corresponding features may share any of the characteristics attributed to either corresponding feature by the present disclosure.

As further shown in FIG. 2, encoder pipeline 230 includes optical flow model 210, which may be implemented using a Recurrent All-Pairs Field Transforms (RAFT) architecture for example, as known in the art, as well as merging and sparsification block 228 and first and second encoders 238a and 238b. It is noted that, in some implementations, each of first and second encoders 238a and 238b may be or include respective temporally-aware entropy encoder networks.

It is further noted that optical flow model 210 corresponds in general to optical flow model 110, in FIG. 1, and those corresponding features may share any of the characteristics attributed to either corresponding feature by the present disclosure. Thus, like optical flow model 210, in some use cases optical flow model 110 may be implemented using a RAFT architecture.

Also shown in FIG. 2 are plurality of video keyframes 236a and 236b partitioned from plurality of video frames 234, forward flows 242 for each of plurality of video frames 234 except plurality of video keyframes 236a and 236b produced using optical flow model 210 (the plurality of video frames 234 except plurality of video keyframes 236a and 236b hereinafter referred to as a “plurality of video inter-frames”), and backward flows 244 for each of the plurality of video inter-frames, also produced using optical flow model 210. In addition, FIG. 2 shows bidirectional flow maps 246 (μ_{0, . . . , k-1}) and optional masks 248 (m_{0, . . . , k-1}) generated by merging and sparsification block 228 using forward flows 242 and backward flows 244. It is noted that bidirectional flow maps 246 include a respective bidirectional flow map for each of the plurality of video inter-frames, while optional masks 248 include a respective mask for each of the plurality of video inter-frames.

Further shown in FIG. 2 are plurality of encoded video keyframes 240 and video decoding metadata 250 included in bitstream 122/222 generated by encoder pipeline 230 based on plurality of video frames 234. It is noted that although FIG. 2 depicts two video keyframes 236a and 236b, which may be the first and last video frames of plurality of video frames 234 for example, that representation is merely provided by way of example. In other implementations, the plurality of video keyframes partitioned from plurality of video frames 234 and encoded by encoder pipeline 230 may include more than two video keyframes.

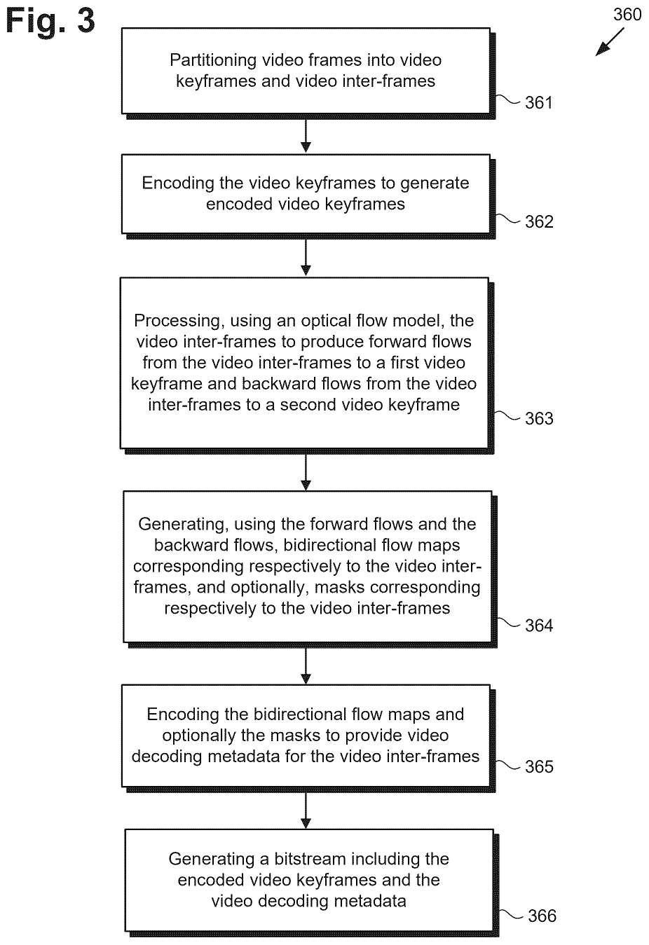

The functionality of video encoder 102 implementing encoder pipeline 230 is further described below by reference to FIG. 3. FIG. 3 shows flowchart 360 outlining an exemplary method for use by video encoder 102 of system 100, according to one implementation. With respect to the method outlined in FIG. 3, it is noted that certain details and features have been left out of flowchart 360 in order not to obscure the discussion of the inventive features in the present application.

Referring to FIG. 3 in combination with FIGS. 1 and 2 flowchart 360 includes partitioning plurality of video frames 234 into a plurality of video keyframes (hereinafter “video keyframes 236a and 236b”), and a plurality of video inter-frames (i.e., as noted above, all video frames included among plurality of video frames 234 except for the plurality of video keyframes) (action 361). As further noted above, plurality of video frames 234 may be a subset of video sequence 232, such as a Group of Pictures (GOP) included in video sequence 232. As further noted above, video keyframes 236a and 236b may include two video keyframes or more than two video keyframes. In some implementations, video keyframes 236a and 236b may include a first video frame and a last video frame of plurality of video frames 234. Partitioning of plurality of video frames 234 into video keyframes 236a and 236b, and the plurality of video inter-frames, in action 361, may be performed by video compression software code 108, executed by hardware processor 104 of video encoder 102.

Continuing to refer to FIGS. 1, 2 and 3 in combination, flowchart 360 further includes encoding video keyframes 236a and 236b to generate plurality of encoded video keyframes 240 (action 362). Plurality of encoded video keyframes 240 correspond to video keyframes 236a and 236b after encoding of video keyframes 236a and 236b using first encoder 238a of encoder pipeline 230. As noted above, in some implementations, first encoder 238a may be or include a temporally-aware entropy encoder network. Encoding of video keyframes 236a and 236b, in action 362, may be performed by video compression software code 108, executed by hardware processor 104 of video encoder 102, and using first encoder 238a.

Continuing to refer to FIGS. 1, 2 and 3 in combination, flowchart 360 further includes processing, using optical flow model 110/210, the plurality of video inter-frames to produce forward flows 242 from the plurality of video inter-frames to a first video keyframe of video keyframes 236a and 236b and a backward flows 244 from the plurality of video inter-frames to a second video keyframe of video keyframes 236a and 236b (action 363). The forward flows can be expressed as f_{i→{0,k}} from i→0 or k, respectively, while the backward flows can be expressed as b_{{0,k}→i} from 0 or k→i, respectively.

It is noted that only forward flows 242 are transmitted and used in the decoding process. However, backward flows 244, freely available at video encoder 102, are used to perform a forward-backwards consistency check to validate the computed flows. For example, a flow vector at p=(x,y) in f_{i→0} is marked valid if:

$${‖ {f}_{i \to 0} ( p ) + {b}_{0 \to i} ( p + {f}_{i \to 0} ( p ) ) ‖}_{2} < τ \qquad ( Equation 1 )$$

for i∈{1, . . . , k−1}, where r is a predefined threshold. A similar consistency check can be performed for f_{i→k}.

The processing of the plurality of video inter-frames, in action 363, may be performed by video compression software code 108, executed by hardware processor 104 of video encoder 102, and using optical flow 110/210. Moreover, in some implementations the described processing of the plurality of video inter-frames may be performed contemporaneously using optical flow model 110/210 to produce forward flows 242 and backward flows 244 in a batch process.

Continuing to refer to FIGS. 1, 2 and 3 in combination, flowchart 360 further includes generating, using forward flows 242 and the backward flows 244 produced in action 363, bidirectional flow maps 246 corresponding respectively to the plurality of video inter-frames, and optionally, masks 248 corresponding respectively to the plurality of video inter-frames (action 364). As is the case for action 363, action 364 is performed for each video inter-frame included among plurality of video frames 234 using the respective forward flow and backward flow for each video inter-frame and based on the validated forward flows to provide a unified representation of the most accurate flows to video keyframes 236a and 236b.

It is noted, moreover, that the validity check performed on forward flows 242 using backward flows 244 in the process of generating bidirectional flow maps 246 advantageously allows for the concurrent masking of the bidirectional flows in areas where neither f_{i→0} nor f_{i→k} is valid. Failure to mask those values would result in incorrect inter-frame predictions and misguide the generative process used on the video decoder side. Formally, a combined flow field μᵢ and trinary mask mᵢ are constructed, where each pixel location p=(x,y) is defined as:

$${μ}_{i} ( p ) = \{ \begin{matrix}{f}_{i \to 0} ( p ) , & if valid \\ {f}_{i \to k} ( p ) , & if {f}_{i \to 0} invalid , but {f}_{i \to k} valid \\ ∅ , & otherwise\end{matrix} \qquad ( Equation 2 )$$

$${m}_{i} ( p ) = \{ \begin{matrix}0 , & if {μ}_{i} ( p ) from {f}_{i \to 0} \\ 1 , & if {μ}_{i} ( p ) from {f}_{i \to k} \\ 2 , & if invalid\end{matrix} \qquad ( Equation 3 )$$

The generation of the bidirectional flow maps 246, and optionally masks 248 using the process described above, in action 364, may be performed by video compression software code 108, executed by hardware processor 104 of video encoder 102, and using merging and sparsification block 228 of encoder pipeline 230.

Continuing to refer to FIGS. 1, 2 and 3 in combination, flowchart 360 further includes encoding bidirectional flow maps 246 and optionally masks 248 provide video decoding metadata 250 for the plurality of video inter-frames (action 365). As shown in FIG. 2, bidirectional flow maps 246 and optionally masks 248 may be encoded, in action 365, using second encoder 238b of encoder pipeline 230. As noted above, in some implementations, second encoder 238b may be or include a temporally-aware entropy encoder network. Encoding of bidirectional flow maps 246 and optionally masks 248 to provide video decoding metadata 250 for the plurality of video inter-frames, in action 365, may be performed by video compression software code 108, executed by hardware processor 104 of video encoder 102, and using second encoder 238b.

Continuing to refer to FIGS. 1, 2 and 3 in combination, flowchart 360 further includes generating bitstream 122/222 including plurality of encoded video keyframes 240 and video decoding metadata 250 (action 366). Bitstream 122/222 may be generated by concatenating or otherwise combining plurality of encoded video keyframes 240 output by first encoder 238a of encoder pipeline 230 with video decoding metadata 250 output by second encoder 238b. It is noted that in some implementations bitstream 122/222 may be a low bit rate bitstream having a bit rate of less than 0.025 bits per pixel. Furthermore, in some implementations, bitstream 122/222 may be an extremely low bit rate bitstream having a bit rate as low as 0.01 bits per pixel. Generation of bitstream 122/222 including plurality of encoded keyframes 240 and video decoding metadata 250, in action 366, may be performed by video compression software code 108, executed by hardware processor 104 of video encoder 102.

With respect to the method outlined by flowchart 360, it is noted that, in some implementations, actions 361-366 may be performed by video encoder 102 in an automated process from which human participation may be omitted.

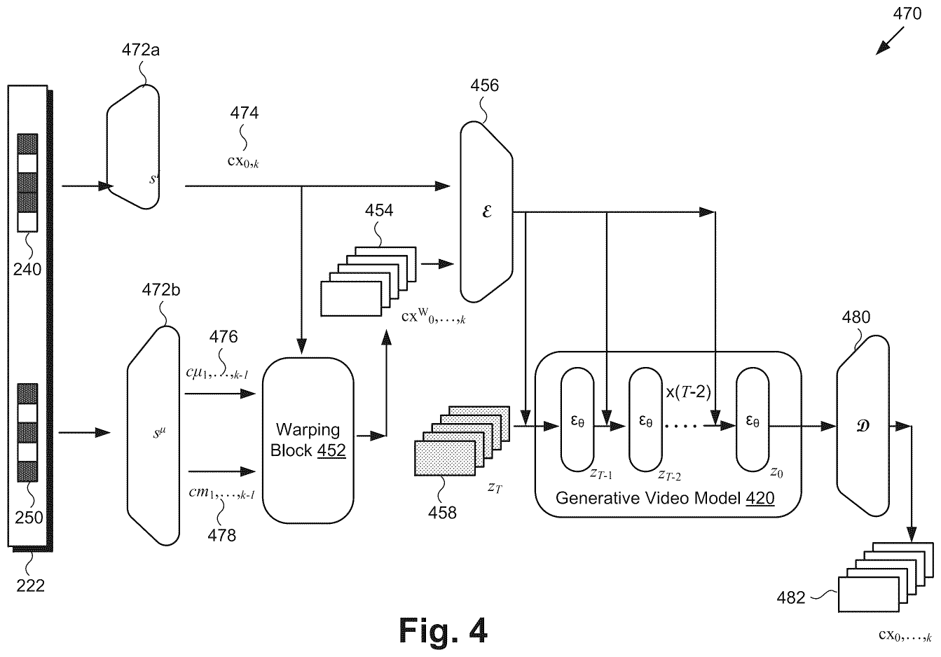

Moving to FIG. 4, FIG. 4 shows a diagram of exemplary decoder pipeline 470 implemented by video decoder 112 in FIG. 1, according to one implementation. Decoder pipeline 470 is configured to receive bitstream 122/222 output by encoder pipeline 230, in FIG. 2, and including plurality of encoded video keyframes 240 and video decoding metadata 250 for the plurality of video inter-frames included among plurality of video frames 234, and to provide plurality of reconstructed video frames 482 corresponding to plurality of video frames 234 including plurality of keyframes 236a and 236b and the plurality of inter-frames, in FIG. 2. As further shown in FIG. 4, decoder pipeline 470 includes first input decoder 472a, second input decoder 472b, warping block 452, optional latent space encoder 456, generative video model 420, which may be or include a diffusion model, and in some implementations may take the form of a conditional latent diffusion model. In implementations in which decoder pipeline 470 includes optional latent space encoder 456, decoder pipeline 470 may further include optional image space decoder 480.

It is noted that generative video model 420 corresponds in general to generative video model 120, in FIG. 1, and those corresponding features may share any of the characteristics attributed to either corresponding feature by the present disclosure. Thus, like generative video model 420, in some implementations generative video model 120 may be or include a diffusion model, such as a conditional latent diffusion model, for example.

Also shown in FIG. 4 are plurality of compressed video keyframes 474 (cx_{0,k}), compressed bidirectional flow maps 476 (cμ_{1, . . . , k-1}) each corresponding respectively to one of the plurality of video inter-frames included among plurality of frames 234 in FIG. 2, optional compressed masks 478 (cm_{1, . . . ,k-1}) each corresponding respectively to one of the plurality of video inter-frames, and plurality of compressed video inter-frame predictions 454 (cx^{W}_{0, . . . ,k}) corresponding to the plurality of video inter-frames. In addition, FIG. 4 shows noisy input 458 (Zₜ) for generative video model produced from plurality of compressed video keyframes 474 and plurality of compressed video inter-frame predictions 454 (cx^{W}_{0, . . . ,k}). It is noted that as used herein, “c” signifies compression. Thus, cxᵢ is a compressed version of the video frame xᵢ, cμ is a compressed version of the bidirectional flow map μ, cm is a compressed version of mask m, and so forth.

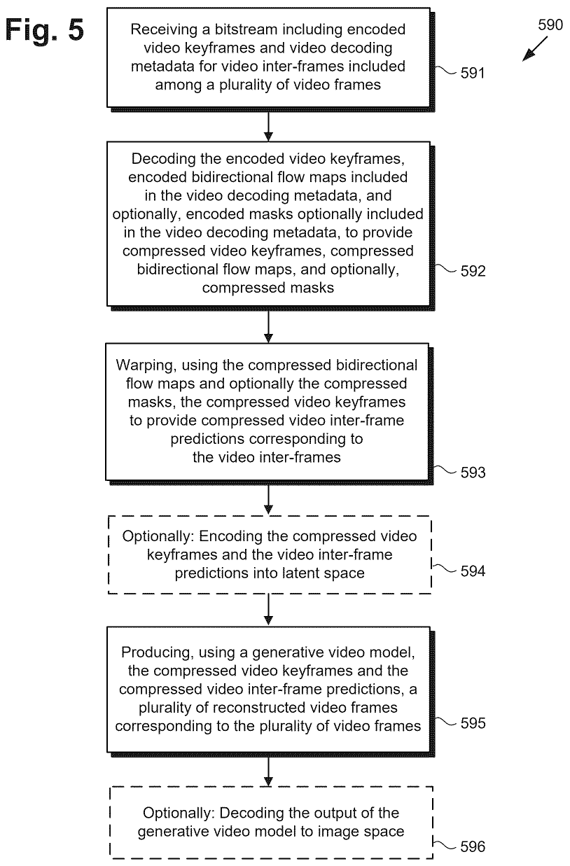

The functionality of video decoder 112 implementing decoder pipeline 470 is further described below by reference to FIG. 5. FIG. 5 shows flowchart 590 outlining an exemplary method for use by video decoder 112 of system 100, according to one implementation. With respect to the method outlined in FIG. 5, it is noted that certain details and features have been left out of flowchart 590 in order not to obscure the discussion of the inventive features in the present application.

Referring to FIG. 5 in combination with FIGS. 1 and 4 flowchart 590 includes receiving bitstream 122/222 including plurality of encoded video keyframes 240 and video decoding metadata 250 for the plurality of video inter-frames included among plurality of video frames 234, in FIG. 2 (action 591). As noted above, video decoding metadata 250 includes an encoded bidirectional flow maps corresponding respectively to the plurality of video inter-frames, and optionally, encoded masks corresponding respectively to the plurality of video inter-frames. As shown in FIG. 1, bitstream 122/222 may be received, in action 591, from video encoder 102 by video decoder 112, via communication network 124 and network communication links 126. Bitstream 122/222 may be received into decoder pipeline 470 by video reconstruction software code 118, executed by hardware processor 114 of video decoder 112.

Continuing to refer to FIGS. 1, 4, and 5 in combination, flowchart 590 further includes decoding plurality of encoded video keyframes 240, the encoded bidirectional flow maps included in video decoding metadata 250 and optionally the encoded masks optionally included in video decoding metadata 250 to provide plurality of compressed video keyframes 474, compressed bidirectional flow maps 476 corresponding respectively to the plurality of video inter-frames, and optionally, compressed masks 478 corresponding respectively to the plurality of video inter-frames (action 592). As shown in FIG. 4, plurality of encoded video keyframes 240 may be decoded using first input decoder 472a of decoder pipeline 470 to provide plurality of compressed video keyframes 474. As further shown in FIG. 4, video decoding metadata 250 may be decoded using second input decoder 472b of decoder pipeline 470 to provide compressed bidirectional flow maps 476 and optional compressed masks 478. Decoding of plurality of encoded video keyframes 240 and video decoding metadata 250 to provide plurality of compressed video keyframes 474, compressed bidirectional flow map 476 and optional compressed masks 478, in action 592, may be performed by video reconstruction software code 118, executed by hardware processor 114 of video decoder 112, and using first input decoder 472a and second input decoder 472b.

Continuing to refer to FIGS. 1, 4, and 5 in combination, flowchart 590 further includes warping, using compressed bidirectional flow maps 476, and optionally, compressed masks 478, plurality of compressed video keyframes 474 to provide compressed video inter-frame predictions 454 (action 593). Action 593 may be performed by video reconstruction software code 118, executed by hardware processor 114 of video decoder 112, and using warping block 452.

Video inter-frame predictions 454 may be expressed as:

$${cx}_{i}^{W} ( p ) = c {x}_{\{ 0 , k \}} ( p + {μ}_{i} ( p ) ) , \qquad ( Equation 4 )$$

where “c” signifies compression, p is the spatial pixel location, and the choice of keyframe (cx₀ or cxₖ) depends on the value of mᵢ. It is noted that in areas with no flow information

$${cx}_{i}^{W} ( p )$$

is set to zero, i.e., no intensity.

Continuing to refer to FIGS. 1, 4, and 5 in combination, in some implementations, flowchart 590 may further include encoding plurality of compressed video keyframes 474 and compressed video inter-frame predictions 454 into latent space (action 594). It is noted that action 594 is optional, and in some implementations may be omitted from the method outlined by flowchart 590. In implementations in which optional action 594 is included in the method outlined by flowchart 590, the encoding of plurality of compressed video keyframes 474 and compressed video inter-frame predictions 454 into latent space may be performed by video reconstruction software code 118, executed by hardware processor 114 of video decoder 112, and using optional latent space encoder 456.

Referring to FIGS. 1, 2, 4, and 5 in combination, flowchart 590 further includes producing, using generative video model 120/420, plurality of compressed video keyframes 474 and compressed video inter-frame predictions 454, plurality of reconstructed video frames 482 corresponding to plurality of video frames 234 (action 595). It is noted that, in some implementations, the number of video frames decoded using generative video model 120/420 may not be identical to the number of video frames included among plurality of video frames 234. It is further noted that in implementations in which the number of video frames included in a batch of frames decoded by generative video model 120/420 differs from the number of video frames included among plurality of video frames 234, the first and last frames the decoded batch can be substituted for plurality of compressed video keyframes 474.

As noted above, in some implementations, generative video model 120/420 may be or include a diffusion model. Moreover, in the exemplary use case depicted in FIG. 4, in which plurality of compressed video keyframes 474 and plurality of compressed video inter-frame predictions 454 are encoded into latent space prior to reconstruction in action 595, generative video model 120/420 may take the form of a conditional latent diffusion model.

In implementations in which generative video model 120/420 is implemented as a conditional latent diffusion model, that diffusion model is designed to perform long-context interpolation, constrained to the correct inter-frame motion via additional motion conditioning. Plurality of compressed video keyframes 474 and compressed video inter-frame predictions 454, after being encoded into latent space in optional action 594, are injected into the diffusion model by concatenating them into noisy input 458 to the diffusion model at every denoising step. The reconstructed video inter-frames included among plurality of reconstructed video frames 482 are then produced by the diffusion model, with faithful textures propagated from the plurality of compressed video keyframes 474, accurate motion inferred from compressed video inter-frame predictions 454, and a realistic appearance ensured by the spatiotemporal prior of the diffusion model.

In the interests of computational efficiency, the exemplary use case depicted in FIG. 4 implements generative video model 120/420 as a conditional latent video diffusion model, which performs the denoising operation in the latent space of a Variational Autoencoder.

Thus, plurality of compressed video keyframes 474 and compressed video inter-frame predictions 454 may be encoded to latent space before conditioning the diffusion model. Formally, each denoising iteration is defined as:

$${z}_{t - 1} = {ϵ}_{θ} ( {z}_{c} , ℰ ( {cx}_{0} ) , ℰ ( {cx}_{k} ) , ℰ ( {cx}^{W} ) , t ) \qquad ( Equation 5 )$$

where “c” signifies compression and concat(⋅) is concatenation along the channel dimension.

Production of plurality of reconstructed video frames 482, in action 595, may be performed by video reconstruction software code 118, executed by hardware processor 114 of video decoder 112, and using generative video model 120/420.

It is noted that although flowchart 590 describes action 595 as following optional action 594, that process flow is presented merely as an example. In implementations in which optional action 594 is not performed, action 595 may follow directly from action 593, and the method outlined by flowchart 590 may conclude with action 595. However, in implementations in which generative video model 120/420 is a conditional latent diffusion model and in which plurality of compressed video keyframes 474 and compressed video inter-frame predictions 454 are encoded to latent space prior to being injected into generative video model 120/420, producing plurality of reconstructed video frames 482, may further include decoding the output of generative video model 120/420 to image space (action 596).

It is noted that action 596 is optional, and in implementations in which optional action 594 is omitted from the method outlined by flowchart 590, action 596 may be omitted as well. However, in implementations in which action 596 is included in the method outlined by flowchart 590, the decoding of the output of generative video model 120/420 may be performed by video reconstruction software code 118, executed by hardware processor 114 of video decoder 112, and using optional image space decoder 480 to provide plurality of reconstructed video frames 482 corresponding to plurality of video frames 234.

With respect to the method outlined by flowchart 590, it is noted that, in some implementations, actions 591, 592, 593 and 595, or actions 591-596, may be performed by video decoder 112 in an automated process from which human participation may be omitted.

Thus, the present application discloses systems and methods for performing low bit rate video compression with generative video models that address and overcome the drawbacks and deficiency in the conventional art. The present video compression solution introduces use of a codec including a generative video model to reconstruct source video at the decoder side by operating on an entire group of pictures (GOP) at once, thereby ensuring temporal consistency and allowing the codec to infer motion dynamics from an entire video sequence. The low bit rate video compression solution disclosed herein operates with minimal motion information using a sparse, bidirectional optical flow to guide the reconstruction process. The present approach achieves state-of-the-art performance in both rate-realism and rate-distortion, demonstrating the advantage of using generative spatiotemporal priors for video compression at bit rates as low as 0.01 bits per pixel.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A video encoder comprising:
a hardware processor; and
a memory storing a video compression software code and an optical flow model;
the hardware processor configured to execute the video compression software code to:
partition a plurality of video frames into a plurality of video keyframes and a plurality of video inter-frames;
encode the plurality of video keyframes to generate a plurality of encoded video keyframes;
process, using the optical flow model, the plurality of video inter-frames to produce a plurality of forward flows from the plurality of video inter-frames to a first video keyframe of the plurality of video keyframes and a plurality of backward flows from the plurality of video inter-frames to a second video keyframe of the plurality of video keyframes;
generate, using the plurality of forward flows and the plurality of backward flows, a plurality of bidirectional flow maps corresponding respectively to the plurality of video inter-frames;
encode the plurality of bidirectional flow maps to provide video decoding metadata for the plurality of video inter-frames; and
generate a bitstream corresponding to the plurality of video frames, the bitstream including the plurality of encoded video keyframes and the video decoding metadata.

2. The video encoder of claim 1, wherein the plurality of video keyframes comprise two video keyframes.

3. The video encoder of claim 1, wherein the plurality of video keyframes comprise a first video frame and a last video frame of the plurality of video frames.

4. The video encoder of claim 1, wherein the hardware processor is further configured to execute the video compression software code to:
generate, using the plurality of forward flows and the plurality of backward flows, a plurality of masks corresponding respectively to the plurality of video inter-frames; and
encode the plurality of masks;
wherein the video decoding metadata includes the encoded plurality of masks.

5. The video encoder of claim 1, wherein the plurality of video inter-frames and are processed contemporaneously using the optical flow model to produce the plurality of forward flows and the plurality of backward flows in a batch process.

6. The video encoder of claim 1, wherein the plurality of video keyframes are encoded using a temporally-aware entropy encoder network of the video encoder.

7. The video encoder of claim 6, wherein the first bidirectional flow map and the first mask are encoded using another temporally-aware entropy encoder network of the video encoder.

8. A video decoder comprising:
a hardware processor; and
a memory storing a video reconstruction software code and a generative video model;
the hardware processor configured to execute the video reconstruction software code to:
receive a bitstream corresponding to a plurality of video frames, the bitstream including a plurality of encoded video keyframes and a video decoding metadata including a plurality of encoded bidirectional flow maps corresponding respectively to a plurality of video inter-frames included among the plurality of video frames;
decode the plurality of encoded video keyframes and the plurality of encoded bidirectional flow maps to provide a plurality of compressed video keyframes and a plurality of compressed bidirectional flow maps for the plurality of video inter-frames;
warp, using the compressed plurality of bidirectional flow maps, the plurality of compressed video keyframes to provide a plurality of compressed video inter-frame predictions corresponding to the plurality of video inter-frames; and
produce, using the generative video model, the plurality of compressed video keyframes and the plurality of compressed video inter-frame predictions, a plurality of reconstructed video frames corresponding to the plurality of video frames.

9. The video decoder of claim 8, wherein the plurality of encoded video keyframes comprise two encoded video keyframes.

10. The video decoder of claim 8, wherein the plurality of encoded video keyframes comprise an encoded first video frame and an encoded last video frame of a sequence of video frames including the plurality of video inter-frames.

11. The video decoder system of claim 8, wherein the received video decoding metadata further includes a plurality of encoded masks corresponding respectively to the plurality of video inter-frames, and wherein the hardware processor is further configured to execute the video reconstruction software code to:
decode the plurality of encoded masks to provide a plurality of compressed masks corresponding respectively to the plurality of video inter-frames; and
wherein warping the plurality of compressed video keyframes to provide the plurality of compressed video inter-frame predictions further uses the plurality of compressed masks.

12. The video decoder of claim 8, wherein the generative video model comprises a diffusion model.

13. The video decoder system of claim 8, wherein before using the generative video model to reconstruct the video sequence, the hardware processor is further configured to execute the video reconstruction software code to:
encode the plurality of compressed video keyframes and the plurality of compressed video inter-frame predictions into latent space.

14. The video decoder of claim 13, wherein the generative video model comprises a conditional latent diffusion model.

15. The video decoder of claim 14, wherein reconstructing the video sequence comprises decoding an output of the conditional latent diffusion model to image space.

16. A method for use by a video processing system, the method comprising:
partitioning, using a video encoder of the video processing system, a plurality of video frames into a plurality of video keyframes and a plurality of video inter-frames;
encoding, by the video encoder, the plurality of video keyframes to generate a plurality of encoded video keyframes;
processing, by the video encoder using an optical flow model, plurality of video inter-frames to produce a plurality of forward flows from the plurality of video inter-frames to a first video keyframe of the plurality of video keyframes and a plurality of backward flows from the plurality of video inter-frames to a second video keyframe of the plurality of video keyframes;
generating, by the video encoder using the plurality of forward flows and the plurality of backward flows, a plurality of bidirectional flow maps corresponding respectively to the plurality of video inter-frames;
encoding, by the video encoder, the plurality of bidirectional flow maps to provide video decoding metadata for the plurality of video inter-frames; and
generating, by the video encoder, a bitstream including the plurality of encoded video keyframes and the video decoding metadata.

17. The method of claim 16, further comprising:
generating, by the video encoder using the plurality of forward flows and the plurality of backward flows, a plurality of masks corresponding respectively to the plurality of video inter-frames; and
encoding, by the encoder, the plurality of masks;
wherein the video decoding metadata includes the encoded plurality of masks.

18. The method of claim 16, wherein the video processing system further includes a video decoder, the method further comprising:
receiving, by the video decoder, the bitstream;
decoding, by the video decoder, the plurality of encoded video keyframes and the plurality of encoded bidirectional flow maps to provide a plurality of compressed video keyframes and a plurality of compressed bidirectional flow maps for the plurality of video inter-frames;
warping, by the video decoder using the plurality of compressed bidirectional flow maps, the plurality of compressed video keyframes to provide a plurality of compressed video inter-frame predictions corresponding to the plurality of video inter-frames; and
producing, by the video decoder using a generative video model, the plurality of compressed video keyframes and the plurality of compressed video inter-frame predictions, a plurality of reconstructed video frames corresponding to the plurality of video frames.

19. The method of claim 18, wherein the generative video model comprises a diffusion model.

20. The method of claim 18, wherein the received video decoding metadata further includes a plurality of encoded masks corresponding respectively to the plurality of video inter-frames, the method further comprising:
decoding, by the video decoder, the plurality of encoded masks to provide a plurality of compressed corresponding respectively to the plurality of video inter-frames; and
wherein warping the plurality of compressed video keyframes to provide the plurality of compressed video inter-frame predictions further uses the plurality of compressed masks.
